(19) United States
(12) Patent Application Publication
(10) Pub. No.: US 2015/0248848 A1
(43) Pub. Date: Sep. 3, 2015

(54) SYRINGE OPERATION DETECTION DEVICE

(71) Applicant: ICST CORPORATION, Saitama (JP)

(72) Inventors: Hiroyuki YOKOI, Saitama (JP); Yusuki OOTAKE, Saitama (JP); Hiroshi NAKASE, Saitama (JP)

(21) Appl. No.: 14/713,673

(22) Filed: May 15, 2015

Related U.S. Application Data
(63) Continuation-in-part of application No. 13/813,332, filed on Jan. 30, 2013.

(30) Foreign Application Priority Data
Jul. 21, 2011 (JP) 2011-159928

(51) Int. Cl. G09B 23/28

(52) U.S. Cl. CPC G09B 23/285

(57) ABSTRACT

A syringe operation detection device includes: a female joint part to be joined to a barrel tip; a male joint part to be joined to a needle hub; a coupling container for allowing the female joint part to be continuous with the male joint part while being closed externally; a detector detecting a pressure, flow velocity, or flow rate of a fluid; and a controller to which a signal from the detector is inputted, the controller including: a sensing section for detecting the signal from the detector; a determination criteria setting section for setting a determination criterion value; and a determination section for determining whether a syringe is operated skillfully or not by comparing sensing data based on the signal with the determination criterion value, and informing a determination result to an operator. As a result, there is provided the syringe operation detection device capable of being applied to a syringe actually used and evaluating an operation state of a syringe in objective terms.

This is a continuation-in-part of U.S. patent application Ser. No. 13/813, 332, filed on Jan. 30, 2013, which is a U.S. National Phase Application of International Patent Application No. PCT/JP2013/068410 filed Jul. 20, 2012 which claims the priority benefit of Japanese Patent Application No. 2011-159928 filed Jul. 21, 2011.

### FIELD

The present invention relates to a syringe operation detection device used when detecting an operation state of a syringe, in particular an operation state of a plunger.

### BACKGROUND

When a healthcare professional such as a doctor or a nurse uses a syringe for the first time, it is necessary to practice how to use it. When practicing blood collection, for example, a blood collection method is learned by using an artificial body created to resemble human skin and flesh and blood vessels, inserting a needle tip of a syringe into an artificial blood vessel inside an artificial skin, and drawing artificial blood as shown in Patent Literature 1. When practicing drug administration, a drug administration method is learned by drawing, with a syringe, a drug used for practice from an ampule used for practice, inserting a needle tip into an artificial blood vessel in an artificial skin, and injecting the drug used for practice.

### CITATION LIST

### Patent Literature

Patent Literature 1: Japanese Patent Application Laid-Open No. 2010-243867

### SUMMARY

### Technical Problem

How much power is applied by an operator to a plunger is crucial for drawing or injection by a syringe. For example, if a plunger is pulled too abruptly at the time of blood collection, platelets and the like in blood may be damaged. Moreover, if a plunger is pushed too abruptly at the time of drug administration, for example, strain on a blood vessel is increased.

However, since how much power is applied to a plunger depends on an individual feel of a hand, it is difficult for a person with experience to teach a beginner. Therefore, whether drawing or injection is being performed in an appropriate state cannot be checked in reality.

It may be conceivable to measure how much power is being applied by fingers to a plunger by means of a load sensor or the like. However, a frictional force between a syringe barrel and a plunger varies depending on a manufacturer or size of a syringe. Thus, it is impossible to figure out whether an appropriate drawing force or injection force is being applied or not. Moreover, even if a syringe dedicated for practice use is manufactured to do practice beforehand, there is a problem that the practice outcome cannot be successfully made use of since various syringes need to be used in medical facilities.

This kind of problem is not limited to the time when a syringe operation is practiced. For example, also when a syringe is actually used in a medical facility or the like, there exists no means for evaluating how much power is being applied to a plunger in objective terms.

The present invention has been made in view of the above-described problems, and an object thereof is to provide a syringe operation detection device capable of being applied to a syringe actually used and evaluating an operation state of a syringe in objective terms.

### Solution to Problem

By the intensive studies made by the present inventors, the above-described object is achieved with the followings means.

The present invention achieving the above-described object is a syringe operation detection device for detecting an operation state of a syringe, the device including: a female joint part to be joined to a barrel tip in a syringe barrel of the syringe; a male joint part to be joined to a needle hub of a syringe needle in the syringe; a coupling container placed between the female joint part and the male joint part, for allowing the female joint part to be continuous with the male joint part while being closed externally; and a detector placed in any one of the coupling container, the female joint part, and the male joint part, the detector detecting a pressure, flow velocity, or flow rate of a fluid moving between the syringe barrel and the syringe needle; and a controller to which a signal from the detector is inputted, the controller including: a sensing section for detecting the signal from the detector; a determination criteria setting section for setting a determination criterion value; and a determination section for determining whether the syringe is operated skillfully or not by comparing sensing data based on the signal with the determination criterion value, and informing a determination result to an operator of the syringe by means of light, an image, or a sound.

The syringe operation detection device of the above-described invention is further characterized in that the determination section calculates a difference between the sensing data and the determination criterion value and a an evaluation value based on a weighting based on the sensing data to determine whether a plunger in the syringe is operated skillfully or not based on magnitude of the evaluation value.

The syringe operation detection device of the above-described invention is further characterized in that the weighting varies between when the sensing data is larger than the determination criterion value and when the sensing data is smaller than the determination criterion value.

The syringe operation detection device of the above-described invention is further characterized in that the weighting is larger when the sensing data is on a hazardous side relative to the determination criterion value than when it is on a safe side.

The syringe operation detection device of the above-described invention is further characterized in that the determination section calculates the evaluation value by multiplying a square of a difference between the sensing data and the determination criterion value or an absolute value of the difference between the sensing data and the determination criterion value by a weighting factor and determines that the syringe is more skillfully operated as the evaluation value is smaller.

The syringe operation detection device of the above-described invention is further characterized in that the weighting varies depending on magnitude of the absolute value of the difference between the sensing data and the determination criterion value or magnitude of the square of the difference between the sensing data and the determination criterion value.

The syringe operation detection device of the above-described invention is further characterized in that the determination section detects a pressure change while the syringe needle is being pierced into an object and determines whether the syringe needle is pierced skillfully or not by comparing the pressure change and the determination criterion value.

The syringe operation detection device of the above-described invention is further characterized in that the determination section detects a pressure change while the syringe needle is being pierced into an object and detects a timing when a tip of the syringe needle reaches an inside of a blood vessel or an artificial blood vessel based on the pressure change.

The syringe operation detection device of the above-described invention is further characterized in that the determination section starts to determine whether the plunger in the syringe is operated skillfully or not from the timing when the tip of the syringe needle reaches the inside of the blood vessel or the artificial blood vessel.

The syringe operation detection device of the above-described invention is further characterized in that the determination criterion value is a time series determination criterion value indicative of an ideal state of the syringe operated by a human.

### Advantageous Effects of Invention

According to the syringe operation detection device of the present invention, it can be freely attached to various syringes and it becomes possible to figure out an operation state of a syringe in objective terms.

### BRIEF DESCRIPTION OF DRAWINGS

FIG. 1 is a diagram showing an entire configuration of a syringe operation detection device according to an embodiment of the present invention.

FIG. 2(A) is an axial cutaway view and FIG. 2(B) is a radial cutaway view showing an intermediate inserting member of the syringe operation detection device in an enlarged manner.

FIG. 3 is a block diagram showing an internal configuration of a controller of the syringe operation detection device.

FIG. 4 is a block diagram showing a functional configuration of the controller of the syringe operation detection device.

FIG. 5(A) and FIG. 5(B) are graphs showing a determination method by the controller of the syringe operation detection device.

FIG. 6 is a side view showing, as an example, a state where the syringe operation detection device is used.

FIG. 7(A) and FIG. 7(B) are diagrams showing another configuration example of the syringe operation detection device.

FIG. 8 is a diagram showing another configuration example of the syringe operation detection device.

FIG. 9(A) and FIG. 9(B) are diagrams showing other configuration examples of the syringe operation detection device, and FIG. 9(C) is a graph showing a determination method by the syringe operation detection device.

### DESCRIPTION OF EMBODIMENT

An embodiment of the present invention will now be described below in detail with reference to the drawings.

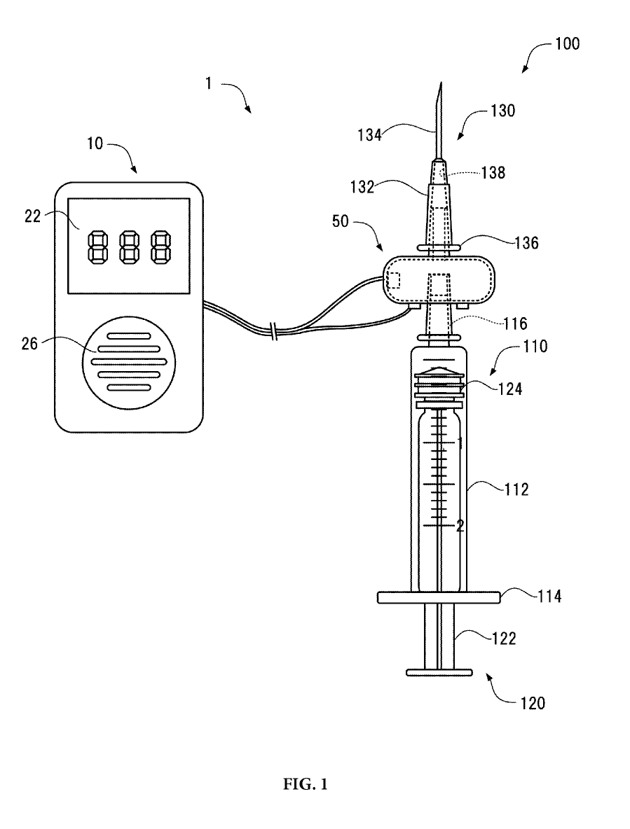

FIG. 1 shows an entire configuration of a syringe operation detection device 1 according to the embodiment of the present invention. The syringe operation detection device 1 is used for a general-purpose syringe 100 and configured to include a controller 10 and an intermediate inserting member 50. Note that there is introduced herein a case where the syringe operation detection device 1 is used when practicing the operation of the syringe 100.

The syringe 100 typically includes: a syringe barrel 110; a plunger 120 to be inserted into the syringe barrel 110; and a syringe needle 130 provided at a tip of the syringe barrel 110. The syringe barrel 110 includes: an outer barrel 112 having a tubular shape with a bottom; a flange 114 provided on an open-ended side of the outer barrel 112 so as to extend in a radial direction; and a barrel tip 116 provided on a bottom (needle tip) side of the outer barrel 112 so as to project in an axial direction. The diameters or lengths of the outer barrel 112 and the flange 114 vary depending on a capacity of the syringe 100. On the other hand, the size of the barrel tip 116 is determined in accordance with the standard since the barrel tip 116 serves as a joint part to the syringe needle 130. Specifically, an outer shape of the barrel tip 116 cannot be joined to a female Luer taper inspection gauge specified by the ISO. The diameter of a tip portion of the barrel tip 116 is set to be 6.0±0.5 mm, the length thereof to be 15 mm or greater, and the taper angle thereof to be 125±25/1000. Although there is illustrated herein a case where the bare barrel tip 116 is used, it may be a locking barrel tip with the circumference thereof being surrounded by an inside screw.

The plunger 120 includes: a rod-shaped pusher 122 to be operated by an operator's hand; and a gasket 124 to be attached to a tip of the pusher 122 for sealing an internal space within the syringe barrel 110 by utilizing the elasticity of a rubber.

The syringe needle 130 includes: a tubular needle hub 132 into which the barrel tip 116 of the syringe 100 is inserted; and a needle tube 134 coaxially placed on a tip side of the needle hub 132. A flange 136 is formed on an open side of the needle hub 132. The size of a needle hub bore 138 formed inside the needle hub 132 is determined in accordance with the standard since the needle hub bore 138 serves as a joint part to the barrel tip 116 of the syringe barrel 110. Specifically, it is required to be unable to be joined to a male Luer taper inspection gauge specified by the ISO and to have a shape capable of being joined to the above-described barrel tip 116.

The intermediate inserting member 50 is inserted between the syringe barrel 110 and the syringe needle 130 in the syringe 100, and detects pressures and flow rates inside the syringe barrel 110 and the syringe needle 130. The controller 10 provides various pieces of information to a learner on the basis of signals of the pressures and the flow rates detected in the intermediate inserting member 50.

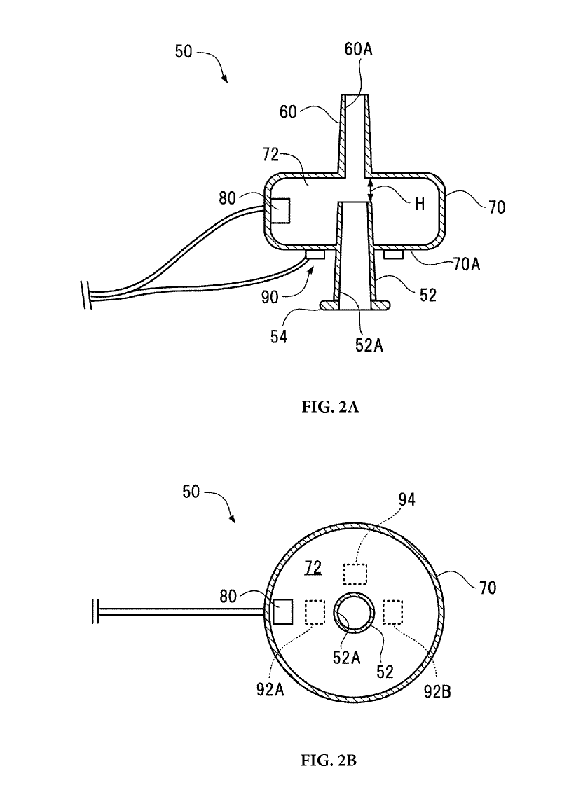

As shown in an enlarged view in FIG. 2, the intermediate inserting member 50 includes: a female joint part 52 to be joined to the barrel tip 116 of the syringe barrel 110; a male joint part 60 to be joined to the needle hub 132 of the syringe needle 130; and a coupling container 70 placed between the female joint part 52 and the male joint part 60 for allowing the internal space of the female joint part 52 to be continuous with that of the male joint part 60 while being closed externally.

The female joint part 52 is formed in a cylindrical shape approximately the same as that of the needle hub 132 of the syringe needle 130. Thus, a joint bore 52A therein cannot be joined to the male Luer taper inspection gauge specified by the ISO and has a shape capable of being joined to the above-described barrel tip 116. A flange 54 extending in the radial direction is further formed at an open end of the female joint part 52.

The male joint part 60 is formed in a cylindrical shape approximately the same as that of the barrel tip 116 of the syringe barrel 110. Thus, an outer shape of the male joint part 60 cannot be joined to the female Luer taper inspection gauge specified by the ISO. The diameter of a tip portion thereof is set to be 6.0±0.5 mm, the length thereof to be 15 mm or greater, and the taper angle thereof to be 125±25/1000. Although there is illustrated herein a case where the bare male joint part 60 is used, it may employ such a locking structure that the circumference thereof is surrounded by an inside screw so as to be screwed with the flange 136 of the needle hub 132.

The coupling container 70 coaxially holds the female joint part 52 and the male joint part 60. An internal space 72 of the coupling container 70 is in an externally-closed state and continuous with the internal spaces of the syringe barrel 110 and the syringe needle 130. Moreover, the internal space 72 extends more in the radial direction thereof than the inner diameters of the female joint part 52 and the male joint part 60. By expanding the internal space 72 in the radial direction thereof as described above, a gap H between the female joint part 52 and the male joint part 60 can be made small as much as possible, while ensuring a space to accommodate a pressure sensor 80, so as to bring them close to each other.

Specifically, the coupling container 70 is a cylindrical container, and the female joint part 52 and the male joint part 60 are placed to be coaxial with the coupling container 70. As a result, the internal space 72 of the coupling container 70 is continuous with the joint bore 52A of the female joint part 52 and an inner periphery 60A of the male joint part 60. As a result, a fluid moving between the syringe barrel 110 and the syringe needle 130 leaks into the side of the internal space 72 through the gap H.

The pressure sensor 80 is placed in the internal space 72 of the coupling container 70. The pressure sensor 80 is placed at a position shifted in the radial direction from the central axis of the female joint part 52 and the male joint part 60. The purpose thereof is to reduce the gap H between the female joint part 52 and the male joint part 60 as much as possible as mentioned previously. The pressure sensor 80 detects a pressure state in the internal space 72 on a real-time basis and transmits a signal thereof to the controller 10.

Furthermore, a flow rate sensor 90 is placed on an outer periphery 70A of the coupling container 70 on an axial direction side thereof. The flow rate sensor 90 detects a flow rate of a fluid flowing through the inside of the female joint part 52. Specifically, the flow rate sensor 90 includes: a pair of electrodes 92A and 92B placed so as to interpose the female joint part 52 therebetween in the radial direction; and an exciting coil 94 placed in a direction perpendicular to this interposing direction, the exciting coil 94 applying a magnetic field to a fluid. When a magnetic field is applied to a fluid flowing through the inside of the female joint part 52 by means of the exciting coil 94, an electromotive force is generated in this fluid, and the electromotive force is then detected by the pair of electrodes 92A and 92B. Although there is illustrated herein a case where a flow rate is detected by utilizing an electromagnetic field, the present invention is not limited thereto. A Karman vortex may be generated in a fluid and then detected by means of ultrasonic waves or the like. Alternatively, electrodes may be placed on both sides of a flow passage and a flow rate may be detected by a change in capacitance therein. Further alternatively, the sensor may be placed so as to be in direct contact with a fluid, thereby directly detecting a flow rate thereof.

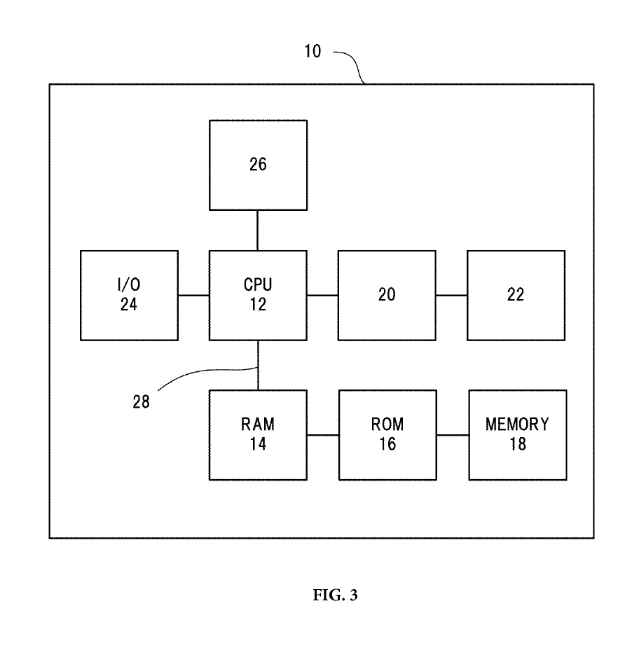

FIG. 3 discloses a hardware configuration of the controller 10. The controller 10 is configured to include a CPU 12, a first storage medium 14, a second storage medium 16, a third storage medium 18, an input device 20, a display device 22, an input and output interface 24, a speaker 26, and a bus 28. The CPU 12 is what is called a central processing unit, and executes various programs to realize various functions of the controller 10. The first storage medium 14 is what is called a RAM (random access memory) and is a memory used as a work area of the CPU 12. The second storage medium 16 is what is called a ROM (read-only memory) and is a memory for storing a basic operating system, a firmware, or the like executed in the CPU 12. The third storage medium 18 is composed of a hard disk device with a built-in magnetic disk, a disk device for accommodating a CD, DVD, or BD, a non-volatile semiconductor flash memory device, or the like and stores therein various programs to be executed in the CPU 12, sensing data from the pressure sensor 80 and the flow rate sensor 90, various reference data set for determination, and the like. The input device 20 is a device such as an input key, a keyboard, a mouse, or the like used for inputting various pieces of information. The display device 22 is a display for displaying sensing results and various determination results. The input and output interface 24 is an interface to which signals of the pressure sensor 80 or the flow rate sensor 90 are inputted, or an interface for externally inputting reference data required for a program or for outputting sensing data to the outside. The speaker 26 informs as an information sound a determined state obtained by a program of the controller 10 to an operator. The bus 28 serves as a line for integrally connecting the CPU 12, the first storage medium 14, the second storage medium 16, the third storage medium 18, the input device 20, the display device 22, the input and output interface 24, the speaker 26, and the like to achieve communication therebetween.

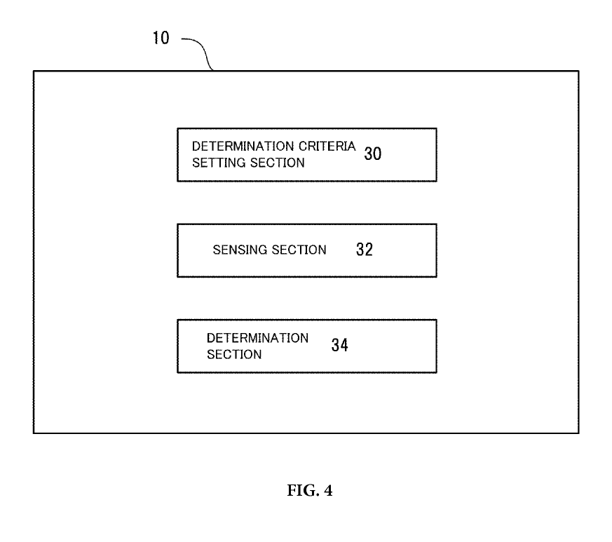

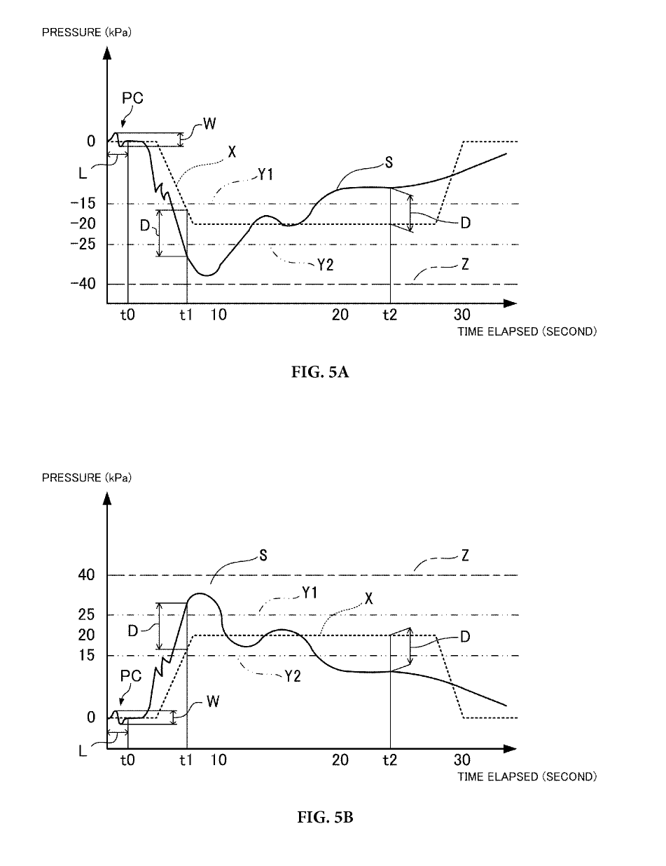

FIG. 4 shows a functional configuration obtained by executing a measuring program stored in the controller 10 at the CPU 12. The controller 10 is configured to include, as its functional configuration, a determination criteria setting section 30, a sensing section 32, and a determination section 34. The determination criteria setting section 30 sets determination criteria used for determining whether an operation of the plunger 120 performed by an operator is skillful or not. For example, an ideal operation criterion value, an ideal upper limit value and an ideal lower limit value, a lowermost limit value and an uppermost limit value, and the like can be set as determination criteria. The ideal operation criterion value is a time series determination criterion value indicative of an ideal state of the syringe operated by a human. As shown in FIG. 5(A), for example, an ideal operation criterion value X of a pressure during an drawing operation of the syringe takes a drawing operation waveform such that the internal space 72 of the coupling container 70 reduces its pressure from 0 kPa to −20 kPa at a constant rate, maintains it at −20 kPa for about 30 seconds, and then raises it up to 0 kPa at a constant rate. Similarly, as shown in FIG. 5(B), for example, an ideal operation criterion value X of a pressure during an injecting operation of the syringe takes a injecting operation waveform such that the internal space 72 of the coupling container 70 raises its pressure from 0 kPa to 20 kPa at a constant rate, maintains it at 20 kPa for about 30 seconds, and then reduces it down to 0 kPa at a constant rate. For example, an ideal upper limit value Y1 and an ideal lower limit value Y2 are fixed threshold values at ±5 kPa from the target value (−20 kPa or 20 kPa). A lowermost limit value Z and an uppermost limit value Z are for determining an abrupt operation of the plunger 120 and, for example, fixed threshold values of −40 kPa and 40 kPa, respectively.

The sensing section 32 detects signals from the pressure sensor 80 or the flow rate sensor 90 during a period of time from the onset of an operation to the completion thereof and records the sensing data on the third storage medium 18. The determination section 34 compares the sensing data detected at the sensing section 32 with a determination criterion value set at the determination criteria setting section 30, makes various determinations, and provides determination output instructions. As specifically shown in FIG. 5, the determination section 34 compares sensing data S with the ideal operation criterion value X. If a difference D therebetween exceeds a predetermined value, the determination section 34 instructs the speaker 26 to emit an alarm sound. Furthermore, the volume level or sound quality of the alarm sound may be varied depending on the magnitude of such a difference D, for example. The determination section 34 also makes a determination on the sensing data S and the ideal upper limit value Y1 and the ideal lower limit value Y2. If the sensing data S is out of a range therebetween, the determination section 34 instructs to emit an alarm sound. Furthermore, the determination section 34 instructs to emit an alarm sound if the sensing data S exceeds the lowermost limit value Z. Although there is illustrated herein a case where a determination result is outputted as an alarm sound, it may be outputted as light; it may be outputted as a numerical value, a level gauge, or the like; or it may be outputted as an image or an audio message. Moreover, although there is illustrated herein a case where the state of an unskillful operation is outputted as an alarm, a preferable operation state may be informed with a sound, light, an image, or the like.

The determination section 34 may determine whether the plunger 120 is operated skillfully or not based on a difference D between the sensing data S and the ideal operation criterion value X as well as a weighting based on the sensing data S. Since a weighting based on the sensing data S is taken into consideration in determining whether the operation is performed skillfully or not, an operator can effectively be directed to a more preferable operation state for the plunger 120.

In this case, the determination section 34 calculates, for example, a square D² of a difference D between the sensing data S and the ideal operation criterion value X at each point of time, and determines whether the plunger 120 is operated skillfully or not based on an evaluation value obtained by weighting the value D². The determination section 34 makes a difference in a weighting between when the sensing data S is larger than the ideal operation criterion value X and when the sensing data S is smaller than the ideal operation criterion value X.

For example, in making a comparison with the ideal operation criterion value X of a pressure in case of a drawing operation of a syringe, the determination section 34 obtains the evaluation value by multiplying the value D² by a predetermined weighting factor that is larger than 1 (for example, 1.5) when the sensing data S is smaller than the ideal operation criterion value X (for example, at a point t1 in FIG. 5(A)), and obtains the evaluation value by taking the value D² as it is (or by multiplying the value D² by a weighting factor of 1) when the sensing data S is larger than the ideal operation criterion value X (for example, at a point t2 in FIG. 5(A)).

In making a comparison with the ideal operation criterion value X of a pressure in case of an injecting operation of a syringe, the determination section 34 obtains the evaluation value by multiplying the value D² by a predetermined weighting factor that is larger than 1 (for example, 1.5) when the sensing data S is larger than the ideal operation criterion value X (for example, at a point t1 in FIG. 5(B)), and obtains the evaluation value by taking the value D² as it is (or by multiplying the value D² by a weighting factor of 1) when the sensing data S is smaller than the ideal operation criterion value X (for example, at a point t2 in FIG. 5(B)).

During a drawing operation of a syringe in blood collection or the like, since the pressure in the internal space 72 of the intermediate inserting member 50 reduces as the operation speed of the plunger 120 increases, a low pressure side from (or the side where the sensing data is smaller than) the ideal operation criterion value X is a hazardous side, and a high pressure side from (or the side where the sensing data is larger than) the ideal operation criterion value X is a safe side. During an injecting operation of a syringe in drug administration or the like, since the pressure in the internal space 72 increases as the operation speed of the plunger 120 increases, a high pressure side from (or the side where the sensing data is larger than) the ideal operation criterion value X is a hazardous side, and a low pressure side from (or the side where the sensing data is smaller than) the ideal operation criterion value X is a safe side.

Consequently, by means of a weighting as described above, when the sensing data S is on a hazardous side relative to the ideal operation criterion value X, the determination section 34 can determine that the state of operation is less skillful than when it is on a safe side even when the difference between the sensing data S and the ideal operation criterion value X is equivalent. The determination section 34 can then inform the determination result to effectively direct the operation by the operator to the safe side.

This means that when the sensing data S is on a hazardous side, an alarm may be presented at an earlier stage, which enables the operator to correct the operation earlier. Furthermore, when the sensing data S is on a safe side, an alarm may be presented at a later stage than when it is on a hazardous side, which restrains the correcting operation by the operator from overshooting to the hazardous side. As a result, the operation by the operator may be directed to the safe side relative to the ideal operation criterion value X, so that the operator can learn a safer operation of the plunger 120.

Furthermore, depending on magnitude of the weighted evaluation value, information modes for the determination result (for example: level, kind and generation cycle of a sound; intensity, color and emission cycle of light; kind, form and color of an image; and a combination thereof) can be changed to effectively direct the operation by the operator. As a result, the operator can learn a safer operation of the plunger 120 in a short time period.

A weighting may also be achieved with an evaluation value obtained by taking the value D² as it is (or by multiplying the value D² by a weighting factor of 1) when the sensing data S is on the hazardous side relative to the ideal operation criterion value X, and with the evaluation value obtained by multiplying the value D² by a weighting factor that is smaller than 1 (for example, 0.7) when it is on the safe side. Instead of achieving a weighting by means of a weighting factor, a weighting may also be achieved by, for example, varying a threshold that causes an alarm or a threshold that causes information modes to change for a determination result.

When the ideal operation criterion value X and the sensing data S are compared for a flow rate, a weighting maybe achieved by assuming the side with a larger flow rate than the ideal operation criterion value X to be a hazardous side and the side with a smaller flow rate to be a safe side, for both of the drawing operation and the injecting operation. When the sensing data S matches with the ideal operation criterion value X, the value D equals to zero, in which case no weighting is required. There may, however, be a formal calculation such as a multiplication for a weighting factor. Needless to say, an evaluation value may be obtained from an absolute value of the value D, instead of D².

The determination section 34 may also make a difference in a weighting based on a distance between the sensing data S and the ideal operation criterion value X, namely, magnitude of an absolute value of the value D (or magnitude of the value D²) . For example, even when the sensing data S is on a safe side relative to the ideal operation criterion value X, a weighting factor may be increased if the distance between the sensing data S and the ideal operation criterion value X is equals to or larger than a predetermined threshold. In this case, it is possible to restrain an operator from being too slow to operate because the operator is too anxious for a safe side, and to direct the operator to a safe and quick operation. Even when the sensing data S is on a hazardous side, a weighting factor may be further increased if the distance between the sensing data S and the ideal operation criterion value X is equals to or larger than a predetermined threshold.

Preferably, the determination section 34 calculates a coincidence degree between the operation by the operator and the ideal operation criterion value X based on a cumulative value (sum) of evaluation values of the respective points of time from the beginning to the end of the operation, and informs the coincidence degree as a determination result. Calculating a coincidence degree as a determination result allows the operation by the operator to be rated in a quantitative manner. It is also possible to make a comparison for inferiority or superiority of operation for a plurality of operators in objective terms.

Also in this case, in addition to the difference D between the sensing data S and the ideal operation criterion value X, a coincidence degree can be determined by taking into consideration a weighting based on the sensing data S to properly rate whether the operation by an operator is skillful or not. In other words, for example, the longer the operation state is in the hazardous side relative to the ideal operation criterion value X, the lower the coincidence degree is. This allows a higher evaluation point to be awarded to a safer operation.

The determination section 34 may also detect a pressure change PC while the syringe needle 130 is being pierced into an object from the sensing data S of the pressure sensor 80. As shown in FIGS. 5(A) and 5(B), after the syringe needle 130 is pierced into a skin (or an artificial skin), the pressure in the internal space 72 of the intermediate inserting member 50 exhibits a characteristic change such that it increases until the tip of the syringe needle 130 reaches the inside of a blood vessel (or an artificial blood vessel) and momentarily decreases down to a negative pressure after the tip of the syringe needle 130 reaches the inside of the blood vessel.

Accordingly, the determination section 34 may also detect a timing t0 when the tip of the syringe needle 130 reaches the inside of the blood vessel by detecting such a characteristic pressure change PC with a known approach such as a pattern matching. In this case, for example, by starting a calculation of the evaluation value from the timing t0, it is possible to properly determine whether an operation of the plunger 120 performed by an operator is skillful or not. Furthermore, in cases where the tip of the syringe needle 130 is diverted from a blood vessel or penetrates through the blood vessel, or where the plunger 120 is operated even though the tip of the syringe needle 130 does not reach the inside of a blood vessel, an alarm can properly be presented. The determination section 34 may also determine whether the syringe needle 130 is pierced skillfully or not by comparing an amplitude W in the pressure change PC, a length L of the pressure change PC, and the like (see FIGS. 5(A) and 5(B)) with a determination criterion value. In this case, whether the operation is performed skillfully or not can be totally determined, and the determination result can be informed, including how the syringe 130 is pierced in addition to the operation of the plunger 120. The determination criterion in this case may be set as a part of the ideal operation criterion value X or may be set as a separate determination criterion.

Note that the pressure change PC may actually be a much smaller change in comparison with a pressure change caused by the operation of the plunger 120, although exaggerated in FIGS. 5(A) and 5(B). When a waveform of the sensing data S is displayed on the display device 22, the pressure change PC may preferably be exaggerated so that an operator can easily recognize.

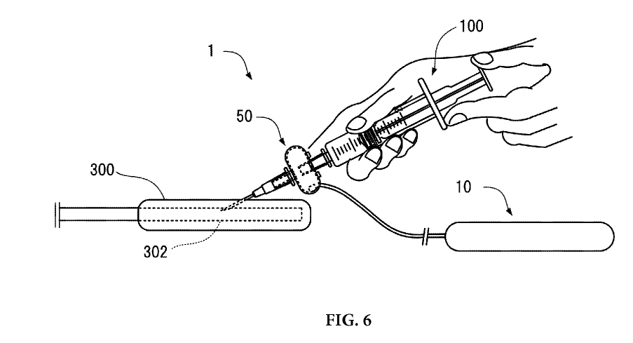

FIG. 6 shows a state where the syringe operation detection device 1 is used. An operator sets the intermediate inserting member 50 of the syringe operation detection device 1 between the syringe barrel 110 of the syringe 100 and the syringe needle 130 and starts the sensing of the controller 10. Thereafter, in practicing blood collection, artificial blood inside an artificial blood vessel 302 is collected by stinging the needle tip of the syringe needle 130 into the artificial blood vessel 302 inside an artificial skin 300 and pulling up the plunger 120. The artificial blood is passed through the inside of the syringe needle 130, spread across the internal space 72 of the intermediate inserting member 50, and further introduced into the syringe barrel 110. In practicing drug administration, the syringe barrel 110 and the internal space 72 of the intermediate inserting member 50 are previously filled with a simulated drug, the tip of the syringe needle 130 is pierced into the artificial blood vessel 302 in the artificial skin 300, and the plunger 120 is pressed down to administer the simulated drug into the artificial blood vessel 302. The simulated drug is introduced from the syringe barrel 110 into the internal space 72 of the intermediate inserting member 50, and then introduced through the inside of the syringe needle 130 into the artificial blood vessel 302. The pressure and flow rate of the artificial blood during blood collection practice and the pressure and flow rate of the dummy drug during drug administration practice are sensed by the pressure sensor 80 and the flow rate sensor 90 and determined by the controller 10. The sensing data S is digitally-represented on the display device 22 on a real-time basis, and the determination result thereof is simultaneously informed with a sound from the speaker 26.

According to the syringe operation detection device 1 of the present embodiment described above, the syringe 100 actually used in medical practice is employed, and a state of the plunger 120 being operated can be detected on the basis of a pressure or flow rate of a liquid inside. Thus, when the syringe operation detection device 1 is used as a practice device, the syringe 100 purchased by the medical facility can be employed as it is, thereby practicing blood collection or drug administration under a condition similar to the actual performance. Moreover, since the intermediate inserting member 50 includes the female joint part 52 and the male joint part 60 capable of fitting with the barrel tip 116 and the needle hub 132 specified by the standard, it can be set to the syringes 100 of various sizes and types.

Furthermore, while the total length of the syringe 100 is increased in some degree due to the intermediate inserting member 50 in which the female joint part 52 and the male joint part 60 are coaxially fixed, the feel of use is almost the same as the actual state. In particular, since the coupling container 70 of the intermediate inserting member 50 has a shape extending more in the radial direction with respect to the female joint part 52 and the male joint part 60 coaxially fixed thereto, a detector such as the pressure sensor 80 can be placed at a position shifted from the central axis of the female joint part 52 and the male joint part 60. As a result, the female joint part 52 and the male joint part 60 can be brought close to each other, thereby allowing the intermediate inserting member 50 to be compactly configured in the axial direction thereof and thus reducing a feeling of strangeness during the use thereof.

Furthermore, according to the syringe operation detection device 1, an operation state can be determined on a real-time basis by the controller 10 and informed to the operator. Thus, it is possible to figure out in objective terms whether one's own operation is skillful or not during the operation of the syringe 100. If the syringe operation detection device 1 is used as a practice instrument, it becomes possible to increase the pace of progress. Since the controller 10 informs an operation state to an operator by means of a sound especially in the present embodiment, the observing point of the operator can be concentrated on the syringe 100.

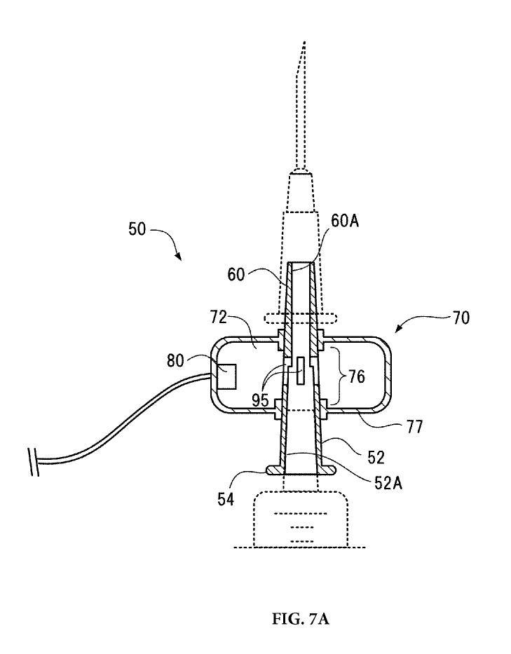

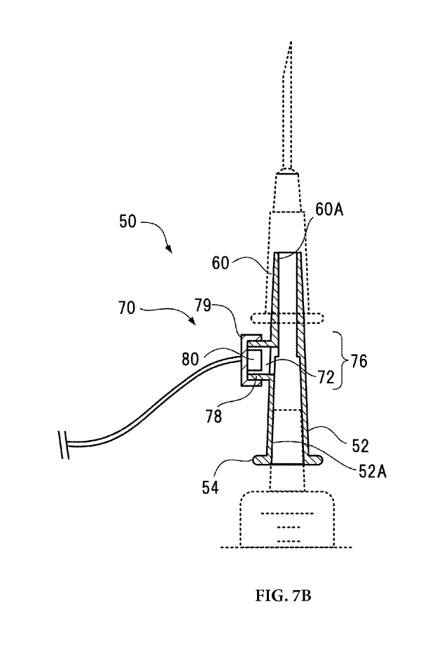

Furthermore, although the present embodiment illustrates a case where the coupling container 70, the female joint part 52, and the male joint part 60 are integrally formed in the intermediate inserting member 50, the present invention is not limited thereto. As shown in FIG. 7(A), for example, it is also preferable that a space between the female joint part 52 and the male joint part 60 be connected with a coaxial connecting region 76 to achieve integral molding and a tubular fit casing 77 be fitted to the outer periphery of the connecting region 76 so as to cover the circumference of the connecting region 76. In this case, the connecting region 76 and the fit casing 77 conceptually function as the coupling container 70 of the present invention. In order to make the internal space 72 of the coupling container 70 continuous with the internal spaces of the female joint part 52 and the male joint part 60, the connecting region 76 is circumferentially provided with a plurality of through holes 95 running through in the radial direction. By forming such a dual-partitioned configuration of the intermediate inserting member 50, a resin molding process thereof is simplified, thereby achieving a reduction in the manufacturing cost.

Alternatively, as shown in FIG. 7(B), for example, it is also preferable that a space between the female joint part 52 and the male joint part 60 be connected with the coaxial connecting region 76 to achieve integral molding and a lead-out tube 78 extending in the radial direction be provided midway along the connecting region 76. A pressure sensor or a flow rate sensor is contained in the lead-out tube 78, and a tip thereof is sealed by a cap 79. In this case, the connecting region 76, the lead-out tube 78, and the cap 79 conceptually function as the coupling container 70 in the present invention, and the inside of the lead-out tube 78 functions as the internal space 72. Although not specifically illustrated herein, it is also possible to connect a tube to the lead-out tube 78 and to place a detector (sensor) at a farther position.

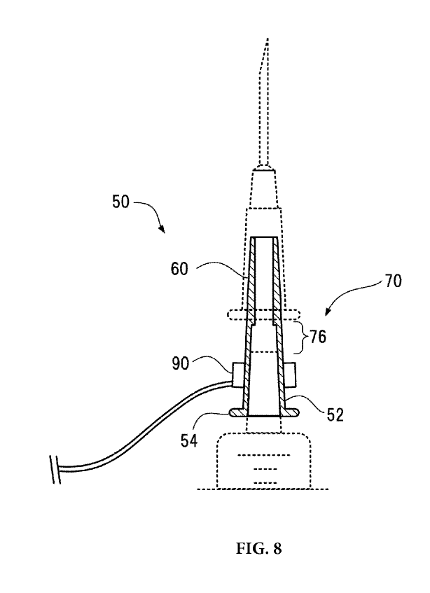

Furthermore, although the present embodiment only illustrates a case where a detector (pressure sensor) is placed within the coupling container 70, the present invention is not limited thereto. As shown in FIG. 8, for example, a space between the female joint part 52 and the male joint part 60 may be connected with the coaxial connecting region 76 (corresponding to the coupling container 70) to achieve integral molding, and a detector (the flow rate sensor 90) may be placed around the side of the female joint part 52. In this manner, it becomes possible to bring the female joint part 52 and the male joint part 60 close to each other further, thereby further downsizing the intermediate inserting member 50 in the axial direction thereof. It is also possible to place a detector (sensor) on the side of the male joint part 60 although the space therefor is smaller.

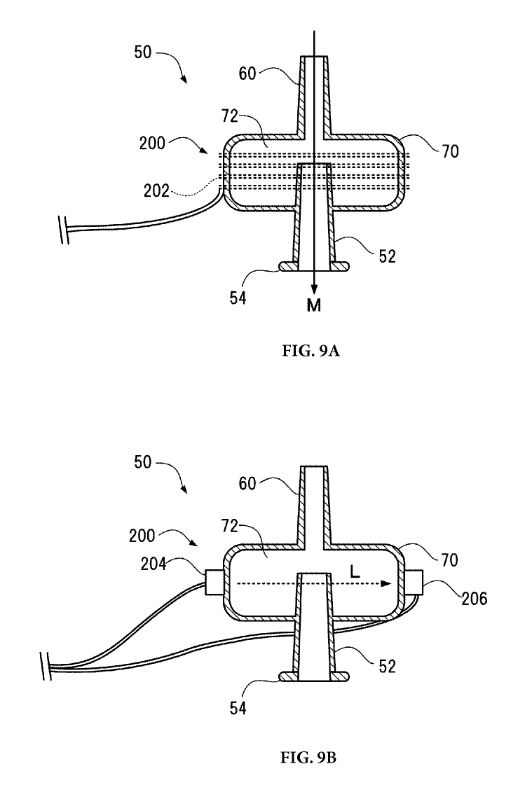

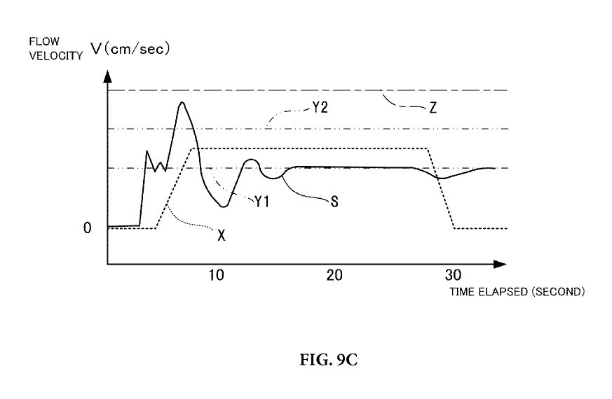

Furthermore, although the present embodiment only illustrates a case where the pressure sensor and the flow rate sensor are placed on the coupling container 70 of the intermediate inserting member 50, the present invention is not limited thereto. As shown in FIG. 9(A), for example, it is also preferred to place a flow velocity sensor 200 in the coupling container 70. The flow velocity sensor 200 includes a cyclic coil 202, and the coil 202 is placed inside or outside the coupling container 70. In this case, a magnetic fluid M is used as artificial blood and passed through the ring of the coil 202. As a result, a flow velocity of the artificial blood can be detected with the coil 202.

A flow velocity sensor 200 shown in FIG. 9(B), for example, includes a light emitting element 204 and a light receiving element 206 placed in the coupling container 70 of the intermediate inserting member 50. The light emitting element 204 emits light L from a direction perpendicular to the flow of the artificial blood. The light receiving element 206 receives the light L having passed through the artificial blood. The flow velocity of the blood can be directly detected by the amount of light detected by the light receiving element 206.

FIG. 9(C) schematically shows a temporal change in flow velocity values V detected by the flow velocity sensor 200 during an operation. As compared to a pressure value shown in FIG. 5, this output is a value corresponding to a first-order differentiation thereof. Thus, the pressure value is obtained by integrating the output value of the flow velocity sensor 200. Therefore, such flow velocity sensing data S is compared to the ideal operation criterion flow velocity value X, and the speaker is made to emit an alarm sound if a difference therebetween exceeds a predetermined value. Alternatively, a determination may be made on the sensing data S and an ideal lower limit flow velocity value Y1 and an ideal upper limit flow velocity value Y2, and an alarm sound may be emitted if the sensing data S is out of a range therebetween. Furthermore, an alarm sound may be emitted when the sensing data S exceeds an uppermost limit flow velocity value Z. Needless to say, various determinations can be made by utilizing a value obtained by integrating the flow velocity value V. Additionally, a weighting may be achieved with the side of higher velocity than the ideal operation criterion value X being a hazardous side and the side of lower velocity being a safe side.

Although the present embodiment illustrates a case where the syringe operation detection device 1 is used for the purpose of practicing a syringe operation, which is one of preferable usages thereof, the present invention is not limited thereto. By using the syringe operation detection device 1 also in the actual medical practice, the accuracy of real blood collection or drug administration can be increased. Moreover, an operation state of the syringe 100 can be stored as objective data. For example, it can be utilized as syringe operation historical data in medical practice.

Note that the syringe operation detection device of the present invention is not limited to the above-described embodiment, and various changes obviously may be made thereto without departing from the scope of the present invention.

### INDUSTRIAL APPLICABILITY

The syringe operation detection device of the present invention is not limited to a use by healthcare professionals. It may be used for various applications where a syringe is operated.

1. A syringe operation detection device for detecting an operation state of a syringe, the device comprising:
a female joint part to be joined to a barrel tip in a syringe barrel of the syringe;
a male joint part to be joined to a needle hub of a syringe needle in the syringe;
a coupling container placed between the female joint part and the male joint part, for allowing the female joint part to be continuous with the male joint part while being closed externally;
a detector placed in any one of the coupling container, the female joint part, and the male joint part, the detector detecting a pressure, flow velocity, or flow rate of a fluid moving between the syringe barrel and the syringe needle; and
a controller to which a signal from the detector is inputted,
the controller comprising:
a sensing section for detecting the signal from the detector;
a determination criteria setting section for setting a determination criterion value; and
a determination section for determining whether the syringe is operated skillfully or not by comparing sensing data based on the signal with the determination criterion value, and informing a determination result to an operator of the syringe by means of light, an image, or a sound.

2. The syringe operation detection device according to claim 1, wherein
the determination section calculates a difference between the sensing data and the determination criterion value and an evaluation value based on a weighting based on the sensing data to determine whether a plunger in the syringe is operated skillfully or not based on magnitude of the evaluation value.

3. The syringe operation detection device according to claim 2, wherein
the weighting varies between when the sensing data is larger than the determination criterion value and when the sensing data is smaller than the determination criterion value.

4. The syringe operation detection device according to claim 3, wherein
the weighting is larger when the sensing data is on a hazardous side relative to the determination criterion value than when it is on a safe side.

5. The syringe operation detection device according to claim 4, wherein
the determination section calculates the evaluation value by multiplying a square of a difference between the sensing data and the determination criterion value or an absolute value of the difference between the sensing data and the determination criterion value by a weighting factor and determines that the syringe is more skillfully operated as the evaluation value is smaller.

6. The syringe operation detection device according to claim 2, wherein
the weighting varies depending on magnitude of the absolute value of the difference between the sensing data and the determination criterion value or magnitude of the square of the difference between the sensing data and the determination criterion value.

7. The syringe operation detection device according to claim 1, wherein
the determination section detects a pressure change while the syringe needle is being pierced into an object and determines whether the syringe needle is pierced skillfully or not by comparing the pressure change and the determination criterion value.

8. The syringe operation detection device according to claim 1, wherein
the determination section detects a pressure change while the syringe needle is being pierced into an object and detects a timing when a tip of the syringe needle reaches an inside of a blood vessel or an artificial blood vessel based on the pressure change.

9. The syringe operation detection device according to claim 8, wherein
the determination section starts to determine whether the plunger in the syringe is operated skillfully or not from the timing when the tip of the syringe needle reaches the inside of the blood vessel or the artificial blood vessel.

10. The syringe operation detection device according to claim 1, wherein
the determination criterion value is a time series determination criterion value indicative of an ideal state of the syringe operated by a human.
